(19) United States
(12) Patent Application Publication
(10) Pub. No.: US 2010/0128046 A1
(43) Pub. Date: May 27, 2010

(54) PARALLEL POISSON DISK SAMPLING

(75) Inventor: Li-Yi Wei, Redwood, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/324,699

(22) Filed: Nov. 26, 2008

(51) Int. Cl. G09G 5/00

(52) U.S. Cl. 345/581

(57) ABSTRACT

Stochastic sample sets with blue noise statistical characteristics are obtained by subdividing a sample domain into cells and drawing samples concurrently from multiple cells which are sufficiently far apart that their samples cannot conflict one another. Cells are traversed in various orders for sampling, such as scanline, grid-partition-plus-scanline, random-partition, random-with-multi-resolution, and grid-partition-plus-random. Sampling may be uniform or adaptive. Poisson disks, Poisson spheres and other higher-dimensional stochastic sample sets may be generated.

### BACKGROUND

In a stochastic point set, the position of any individual point is subject to randomness but the overall distribution of the points as a set is subject to a statistical constraint. Stochastic point sets with certain desirable characteristics have applications in computer graphics, such as modeling, dithering, half-toning, geometry instancing, distribution of objects in an illustration, procedural texture generation, and non-photorealistic rendering. Desirable characteristics include, for example, a “blue noise” distribution, e.g., few low frequency components and no spikes. Poisson disks are one example of two-dimensional stochastic sample sets which have distributions useful in computer graphics.

### SUMMARY

Sample sets are important for a variety of graphics applications such as rendering, imaging, and geometry processing. Some embodiments discussed herein efficiently produce stochastic sample sets with blue noise statistical characteristics by subdividing a sample domain into cells and drawing samples concurrently from multiple cells which are sufficiently far apart that their samples cannot conflict one another. For example, some embodiments generate a Poisson disk sample set by specifying a collection of cells which are bounded in size, and then adding samples to the sample set in parallel while traversing the cells in a traversal order. Each added sample is at least a specified distance r from any other added sample, and the added samples collectively form a Poisson disk or other stochastic set. Poisson spheres and other higher-dimensional stochastic sample sets may also be generated. Example cell traversal orders include scanline, grid-partition-plus-scanline, random-partition, random-with-multi-resolution, and grid-partition-plus-random. The sampling process transforms the indeterminate candidate set of a domain of cells into a definite stochastic sample set.

Some embodiments perform uniform sampling by using a fixed value for the minimal distance r, whereas other embodiments perform adaptive sampling by using a distance function r(.) which is defined over a sampling domain. Some embodiments use a multi-resolution approach, specifying a sequence of grids with successively smaller cells. Some embodiments organize the cells in an n-dimensional tree of nodes in a sampling domain.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having a processor, a memory, at least one computer graphics application program, and other items in an operating environment, and also illustrating configured storage medium embodiments;

FIG. 2 is a block diagram further illustrating stochastic sample set generators; and

FIG. 3 is a flow chart illustrating steps of some method and configured storage medium embodiments.

### DETAILED DESCRIPTION

Overview

Sampling is important for a variety of graphics applications include rendering, imaging, and geometry processing. However, producing sample sets with desired efficiency and blue noise statistics has been a major challenge using methods which are either sequential with limited speed, or are parallel but only through pre-computed datasets and thus fall short in producing samples with blue noise statistics. Some embodiments presented herein use or provide a Poisson disk sampling process that runs in parallel and produces all samples on the fly with desirable blue noise properties. Toward that end, some embodiments subdivide a sample domain into grid cells and draw samples concurrently from multiple cells that are sufficiently far apart so that their samples cannot conflict with one another. Some embodiments use or provide a parallel implementation of the sampling process running on a graphics processing unit (GPU) with constant cost per sample and constant number of computation passes for a target number of samples. Some embodiments use or provide a sampling process that works in an arbitrary finite dimension, and allows adaptive sampling from a user-specified importance field. Once understood, the sampling processes can be readily implemented, and they may run faster than alternative sampling techniques.

Sampling remains a core process in computer graphics, used with a variety of applications. The number and distribution of the samples employed may determine the speed of graphics computation and quality of results. In some cases a Poisson disk sampling distribution yields better image quality than alternative distributions with similar numbers of samples. A Poisson disk distribution has samples that are randomly located but remain at least a minimum distance r apart from one another. Examples of Poisson disk distributions are readily available.

In particular, some examples of Poisson disk distributions are shown in Li-Yi Wei, “Parallel Poisson Disk Sampling”, March 2008, a reference which is available online as document TR-2008-46 from research dot Microsoft dot corn or from the present patent application's submitted references, and which is referred to herein as “Wei”. Wei includes academic citations to documents discussing sampling, as well as an earlier view of embodiments discussed herein and implementation details. Wei also includes figures illustrating sampling results, including some samples produced in a manner consistent with processes described herein, and some produced by other processes such as dart throwing.

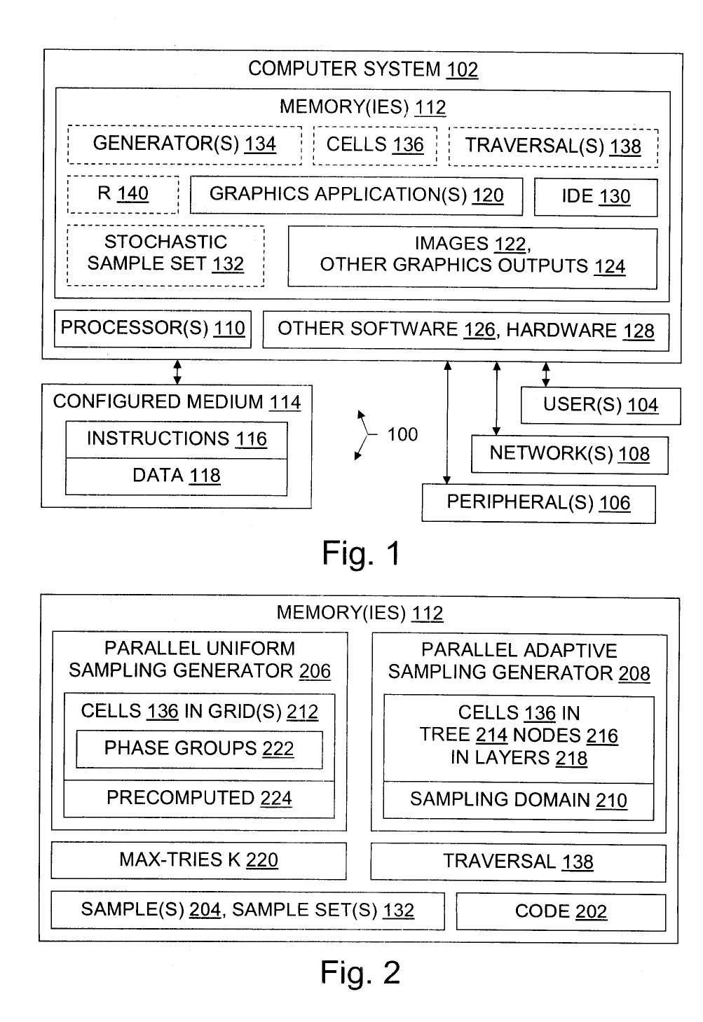

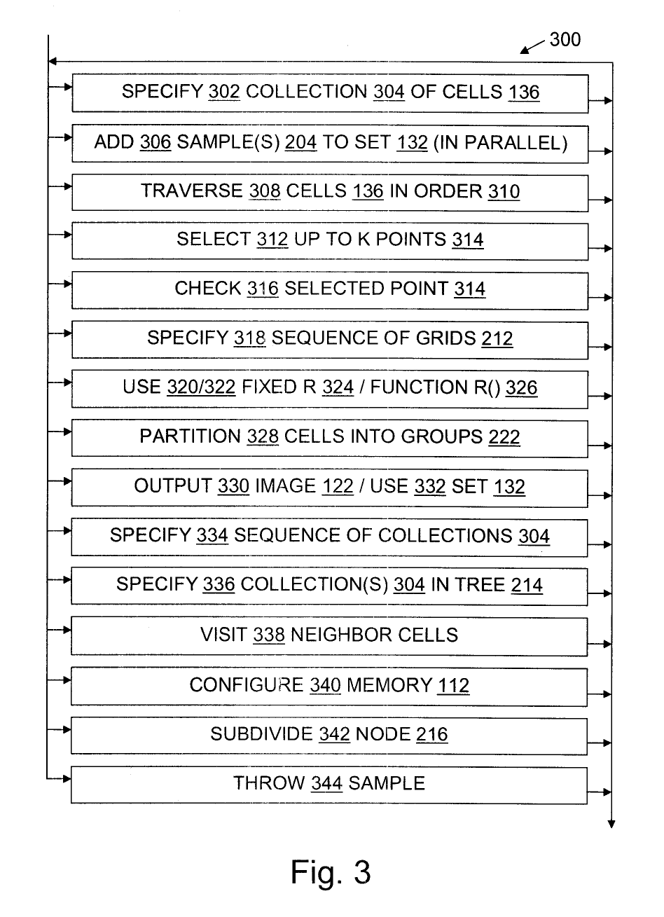

Although the Wei figures are not necessary to make or use embodiments discussed herein or otherwise essential material, the Wei figures may still be of interest, e.g., as examples of output from a particular implementation using particular parameter values. Also, some of the Wei figures are in color and are thus able to convey details of particular implementation results more readily than the black-and-white drawings deemed acceptable in patent applications. Accordingly, comments regarding some Wei Figures are included herein, based on the figure captions in Wei. To avoid confusion, the Wei figures are identified herein as Figure Wei-1, Figure Wei-2, and so on. By contrast, the patent figures discussed herein are identified as FIG. 1, FIG. 2, and FIG. 3, together with reference numbers correlating textual discussion with items in the patent figures.

Figure Wei-1 shows Poisson disk samples produced with an implementation of a process discussed herein. Color images provided include screen shots from an implementation running on a GPU, producing 2D samples in a parallel and multi-resolution process. Pixel colors represent sample locations with black indicating absence of any sample. A final set of 2D samples is shown. The implementation also works for arbitrary dimensions as demonstrated in a 3D case shown in Figure Wei-1 with samples visualized as small spheres. The GPU implementation generates more than 4 million 2D samples/second and 555 thousand 3D samples/second. In the 2D case, parameter values include a distance r=0.02, and the number of samples=1657. In the 3D case, r=0.07, and the number of samples=1797. A max-tries parameter k=4 for all images shown in Wei unless stated otherwise.

The Fourier spectrum of a set of Poisson disk samples exhibits blue noise property with low anisotropy and a small amount of low frequency energy. Figure Wei-4 shows a spectrum comparison between an implementation of a process discussed herein and a dart throwing implementation for 2D sampling. Figure Wei-4 illustrates a power spectrum averaged over 10 runs, radial mean power, and radial variance/anisotropy. The radial mean is normalized against a reference white noise with mean power 1. An anisotropy of −10 dB is considered background noise.

In essence, a blue noise sampling produces visually pleasing results by replacing low frequency aliasing with high frequency noise, a less visually annoying effect. Desired properties of a sampling process implementation may include blue noise spectrum and fast computation. Some approaches that exhibit blue noise spectrum are too slow for applications requiring a large number of samples, e.g., dart throwing. Their efficiency may be improved by techniques such as pre-computed datasets or computing samples on the fly. However, despite their run-time efficiency, the pre-computed-dataset approaches may consume significant memory for storing data and could fall short in producing desired blue noise spectrums.

Figure Wei-6 includes a spectrum comparison between an implementation of a process discussed herein and techniques that use pre-computed datasets, showing a power spectrum averaged over 10 runs, radial mean power, and radial variance/anisotropy. Techniques illustrated include Wang tiling, Corner-based tiling, P-pentominoes, G-hexominoes, and an implementation of techniques taught herein. The Wang tiling case consists of 32768 samples, generated by a 4×4 tiling with 2048 samples per tile. The corner-based tiling case consists of 33856 samples, generated by a 23×23 tiling with 64 samples per tile. The P-pentomino case consists of 32000 samples, generated by a 10×10 tiling of 20×20 patches with 2 levels of subdivision. The G-hexomino case consists of 31104 samples, generated via a deterministic tiling process. The implementation of techniques taught herein (r=0.0044, # samples ˜32K) produced better results as demonstrated both by the power spectrum image and the anisotropy plot. Under a similar number of samples, results produced by G-hexominoes have a larger inner ring than the implementation of techniques taught herein, due to the use of Lloyd relaxation. This translates to a more uniform spatial layout of samples, as illustrated in Figure Wei-8, which shows a spatial sample layout comparison in the form of zoom-in views of samples generated for Figure Wei-6. The G-hexominoes approach produced a more uniform spatial distribution than the implementation of techniques taught herein.

Even though some computation-on-the-fly approaches introduced elsewhere can produce blue noise power spectrums, they are apparently sequential in nature. This imposes an upper limit on the achievable computation speed and prevents these approaches from taking advantage of advances in parallel computing architectures such as GPUs and multi-core CPUs.

Some embodiments discussed herein teach a parallel implementation that generates all samples on-the-fly with blue noise spectrums very similar to the ground truth produced by dart throwing. Some embodiments subdivide a sample domain into square-shaped grid cells and draw samples concurrently from multiple cells that are sufficiently far apart so that their samples cannot conflict with one another (i.e. be within the specified minimum distance). Care is taken in sampling and traversing the grid cells to avoid introducing biases. Some embodiments use a multi-resolution process suitably modified for use as taught herein. A parallel implementation running on a GPU provides a constant cost per sample and a constant number of computation passes for a target number of samples, allowing a parallel generation of Poisson disk samples entirely on-the-fly.

As an added benefit, some embodiments also work in dimensions higher than 2D. Although 2D sampling has a variety of important applications, sampling in higher dimensional space is helpful or required for at least some other applications, such as depth of field, motion blur, and global illumination, even though Poisson disk sampling might not be the best option for all high-dimensional applications. In some applications, using multiple slices of 2D Poisson samples is insufficient. One possible solution is to extend the pre-computed-dataset approaches in 2D to high dimensions, e.g., Wang cubes, but such approaches may incur combinatorial explosion in the amount of pre-computed datasets. A more feasible approach has been to compute all samples on-the-fly; hence the arbitrary dimensionality of embodiments discussed herein. Beyond quality, parallelism, and arbitrary dimensionality, some embodiments also allow adaptive sampling. An implementation of sampling processes taught herein may also run faster than implementations of alternative techniques.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventor asserts and exercises his right to his own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on. In particular and without further limitation, a graphics processing unit (GPU) is an example of a logical processor.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Code” means processor instructions, data (which includes constants, variables, and data structures), or both instructions and data.

A “stochastic sample set” is a set of samples based on random locations but subject overall to a statistical characterization. The specific location of individual samples in a stochastic sample set cannot be predicted, but the distribution of sample locations follows a predictable pattern, e.g., a Poisson distribution.

Throughout this document, use of the optional plural “(s)” means that one or more of the indicated feature is present. For example, “sample(s)” means “one or more samples” or equivalently “at least one sample”.

Whenever reference is made to data or instructions, it is understood that these items configure a computer-readable memory thereby transforming it to a particular article, as opposed to simply existing on paper, in a person's mind, or as a transitory signal on a wire, for example.

Operating Environments

With reference to FIG. 1, an operating environment 100 for an embodiment may include a computer system 102. The computer system 102 may be a multiprocessor computer system, or not. An operating environment may include one or more computer systems, which may be clustered, client-server networked, and/or peer-to-peer networked. Some operating environments include a stand-alone (non-networked) computer system.

Human users 104 may interact with the computer system 102 by using displays, keyboards, and other peripherals 106. System administrators, developers, engineers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example.

The computer system 102 includes at least one logical processor 110, which may be a CPU or a GPU, for example. The computer system 102, like other suitable systems, also includes one or more memories 112. The memories 112 may be volatile, non-volatile, fixed in place, removable, magnetic, optical, and/or of other types. In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a memory 112. Other examples of memory 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the memory 112/medium 114 in which they reside; when that memory is a functional part of a given computer system, the instructions 116 and data 118 also configure that computer system.

Memories 112 may be of different physical types. Graphics applications 120, images 122, other graphics outputs 124 such as textures and geometries, kernel(s) and other software 126, and other items shown in the Figures may reside partially or entirely within one or more memories 112, thereby configuring those memories. An operating environment may also include other hardware 128, such as cameras or graphics accelerators, for instance.

A given operating environment 100 may include an Integrated Development Environment (IDE) 130 which provides a developer with a set of coordinated software development tools. In particular, some of the suitable operating environments for some embodiments include or help create a Microsoft® Visual Studio® development environment (marks of Microsoft Corporation) configured to support program development. Some suitable operating environments include Java® environments (mark of Sun Microsystems, Inc.), and some include environments which utilize languages such as C++ or C# (“C-Sharp”), but teachings herein are applicable with a wide variety of programming languages, programming models, and programs, as well as with endeavors outside the field of software development that use computer graphics.

Systems

With regard to FIGS. 1 and 2, in some embodiments peripherals 106 such as human user I/O devices (screen, keyboard, mouse, tablet, microphone, speaker, motion sensor, etc.) will be present in operable communication with one or more processors 110 and memory 112. However, an embodiment may also be deeply embedded in a system, such that no human user 104 interacts directly with the embodiment. Software processes may be users 104.

In some embodiments, networking interface equipment provides access to networks 108, using components such as a packet-switched network interface card, a wireless transceiver, or a telephone network interface, for example, will be present in the computer system. However, an embodiment may also communicate through direct memory access, removable nonvolatile media, or other information storage-retrieval and/or transmission approaches, or an embodiment in a computer system may operate without communicating with other computer systems.

Some embodiments include a computer system 102 configured with a stochastic sample set 132. The system includes a logical processor 110, and a memory 112 in operable communication with the logical processor. The memory is configured with a stochastic sample set 132 and with code 202 for controlling the logical processor. The code 202 may include, for example, one or more stochastic sample set generators 134 and graphics applications 120 such as renderers. The stochastic sample set may be, for example, a Poisson disk sample set or a higher-dimensional Poisson-distributed sample set.

The stochastic sample set is produced by the system performing, with the code, a method that includes specifying a sequence of cell 136 collections, and adding samples 204 to the sample set in parallel. In some embodiments, each successive collection has cells smaller than the preceding collection. The samples 204 are added to the set 132 while traversing the collection cells in an order defined by a traversal 138. For example, some traversal orders visit cells of a given maximum size before visiting smaller cells. Each sample added to the stochastic set is at least a specified distance r 140 from any other added sample.

In some embodiments, the system is configured with a uniform sampling generator 206 designed for parallel uniform sampling, in which the specified distance r 140 is a fixed value. In some other embodiments, the system is configured with an adaptive sampling generator 208 for parallel adaptive sampling, in which the cell collections are specified in a sampling domain 210 and the specified distance r 140 is provided by a function r(.) 140 over the sampling domain. The cell 136 collections for parallel uniform sampling may be specified in one or more grids 212, while the cell 136 collections for parallel adaptive sampling may be specified in an n-dimensional tree 214. In some embodiments, a generator 134 performs uniform sampling in a sequential manner, rather than a parallel manner.

Methods

FIG. 3 illustrates some method embodiments in a flowchart 300. Methods shown in the Figures may be performed in some embodiments automatically, e.g., by sample set generators 134 and graphics applications 120 under control of a script requiring little or no user input. Methods may also be performed in part automatically and in part manually unless otherwise indicated. In a given embodiment zero or more illustrated steps of a method may be repeated, perhaps with different parameters or data to operate on. Steps in an embodiment may also be done in a different order than the top-to-bottom order that is laid out in FIG. 3. Steps may be performed serially, in a partially overlapping manner, or fully in parallel. The order in which flowchart 300 is traversed to indicate the steps performed during a method may vary from one performance of the method to another performance of the method. The flowchart traversal order may also vary from one method embodiment to another method embodiment. Steps may also be omitted, combined, renamed, regrouped, or otherwise depart from the illustrated flow, provided that the method performed is operable and conforms to at least one claim.

During a cell collection specifying step 302, an embodiment specifies at least one collection 304 of cells 136. A collection 304 may take the form of a grid 212, or a collection may take the form of a tree 214 with nodes 216 in layers 218, for example.

During a sample adding step 306, an embodiment adds one or more samples 204 to a sample set 132. In some embodiments, samples are added 306 sequentially, while in other embodiments samples are added 306 in parallel, that is, concurrently.

During a traversing step 308, an embodiment traverses cells 136 in a particular order 310, such as a scanline order or a random order. The traversal order 310 is also referred to herein as a traversal 138.

During a point selecting step 312, an embodiment selects up to k points 314 to check; points 314 are prospective samples 204. In some embodiments, k is 1 while in others k is an integer greater than 1. This parameter k is designated as max-tries k 220 in FIG. 2.

During a point checking step 316, an embodiment checks a selected 312 point 314 to determine whether to add 306 the selected point to a sample set 132 as a sample 204.

During a grid sequence specifying step 318, an embodiment specifies a sequence of grids 212, e.g., during a multi-resolution sampling process. Specifying an individual grid is an example of cell collection specifying step 302.

During a fixed distance using step 320, an embodiment uses a fixed distance value r 324 while producing a sample set 132. During a variable distance using step 322, an embodiment uses a function to provide a variable distance value r( ) 326 while producing a sample set 132. The fixed distance r and the function r( ) are each examples of the distance designated as r 140 in FIG. 1.

During a partitioning step 328, an embodiment partitions a collection of cells into two or more groups 222.

During an image outputting step 330, an embodiment outputs an image 122 to a frame buffer, a display, or a file, for example.

During a sample set using step 332, an embodiment uses a sample set 132. For example, a graphics application 120 in an embodiment may use 332 a sample set for modeling, dithering, half-toning, geometry instancing, distribution of objects in an illustration, procedural texture generation, or rendering.

During a cell collection sequence specifying step 334, an embodiment specifies a sequence of cell collections 304, e.g., during a multi-resolution sampling process. Specifying 318 a sequence of grids is an example of cell collection sequence specifying step 334.

During a tree collection specifying step 336, an embodiment specifies at least one collection 304 of cells in an n-dimensional tree 214, which may include specifying nodes 216 and layers 218 of the tree 214.

During a neighbor visiting step 338, an embodiment visits neighbor cells 136 of a particular cell, while traversing 308 cells.

During a memory configuring step 340, an embodiment configures a memory 112 by forming or otherwise producing therein a sample set 132 or other item, as discussed herein. Memory configuring step 340 may include, for example, one or more of the following steps: adding 306 samples, specifying 302, 318, 334, 336 cell collection(s), partitioning 328 cells, outputting 330 an image or other graphics output 124.

During a node subdividing step 342, an embodiment subdivides a tree node 216, thereby forming smaller nodes to serve as cells 136.

During a sample throwing step 344, an embodiment throws potential samples (points 314) to be tested for conflicts that would prevent adding 306 the points as samples.

The foregoing steps and their interrelationships are discussed in greater detail below, in connection with various embodiments and in particular in connection with operation of the various sample set generators 134.

Some embodiments provide a method for generating a stochastic sample set for use in graphics production, including the step of specifying 302 a collection 304 of cells 136 which are bounded in size to each contain at most one sample 204 when samples are at least a specified distance r 140 from one another, and also including the step of adding 306 samples to the sample set in parallel while traversing 308 the cells in a traversal 138 order. Each added sample is at least a specified fixed distance r(which may be fixed or may be given as a specified variable distance r( )) from any other added sample, and the added samples collectively form the stochastic set. In some embodiments, the cells 136 are bounded in size by r divided by the square root of n, where n is an integer greater than 1 representing the dimensionality of a sampling domain 210 from which the sample set is generated.

In some embodiments, the method further includes randomly selecting 312 up to k points 314 within a given cell. A randomly selected point is added 306 to the sample set if it is at least the specified distance r from each point already in the sample set. The given cell is left empty of samples and the method continued by traversing other cells if none of the k randomly selected points is at least the specified distance r from each point in the sample set. The max-tries parameter k is a positive integer.

In some embodiments, the traversal 138 order visits cells in a random order. In some, the collection cells are organized in a grid 212, the method specifies 318 a sequence of grids with each successive grid having cells smaller than the preceding grid (samples are still at least a specified distance r from one another), and the traversal 138 order visits cells of a given maximum size before visiting smaller cells. That is, the traversal visits cells in an order that is not entirely random. However, the traversal may visit the cells of a given maximum size in a random order.

In some embodiments, the collection cells are organized in an n-dimensional tree 214 of nodes 216 in a sampling domain 210. The specified distance r 140 is provided by a function r( ) over the sampling domain.

Operation of the various generators 134 will now be described in greater detail. Sequential uniform sampling is discussed first, followed by parallel uniform sampling and then by parallel adaptive sampling. A given embodiment may include one or more generators 134 of one or more different kinds.

Sequential Uniform Sampling

A sequential uniform sampling generator 134 draws samples uniformly from square-shaped grid cells. Parallel uniform sampling performs this operation concurrently and independently for all grid cells that are sufficiently far apart. However, grid-based sampling can easily introduce bias. A discussion below begins with a sequential sampling process, and how to reduce or eliminate biases. A parallel sampling process can be developed from this, as described in the next section of the discussion.

Given an n-dimensional sampling domain 210 and a minimum distance r 140 between samples, one first specifies 302 a grid 212 around the domain with grid cell 136 size bounded by r/√n (where n is the dimensionality of the sample space) so that each grid cell contains at most one sample 204. An effect of requiring at most one sample per cell will be apparent below in discussing a GPU implementation. One then traverses 308 the grid cells in a certain order, as discussed below. For each grid cell, one selects 312 up to max-tries k 220 new candidate sample points 314 randomly drawn within the cell. The first new sample point that is not within a distance r 140 from any existing sample is accepted as legal and is added 306 to the cell, and the process moves on to the next cell. If all k samples are rejected when checked 316, then the process leaves the cell empty. Different traversal 138 orders give different results; some traversals are better than others at producing sample sets 132 which have a blue noise spectrum.

A scanline order traversal 138 visits the cells in a scanline order. This traversal is not parallelizable, but it can be used to illustrate potential sources of bias from grid-based sampling. For example, Figure Wei-2 shows a result sample set containing bias manifested in peaks and twisted rings of a corresponding Fourier spectrum. The peaks are located at frequencies equal to the number of grid cells per dimension. There are two possible reasons for such artifacts: first, the grid cells are visited in a scanline order, and second, each sample is uniformly sampled from a grid cell. These two possibilities are discussed below.

A random-with-multi-resolution traversal 138 attacks the first artifact issue (use of scanline order) by randomizing the traversal order while still visiting each cell exactly once. A resulting spectrum, shown in Figure Wei-2, confirms that the scanline order bias is removed by randomizing the traversal order.

However, there still exists some bias in the spectrum image (indicated by white spikes in Figure Wei-2) caused by the fact that each sample is uniformly sampled from a grid cell. To attack those biases, a multi-resolution approach is used, namely, the allowable sampling regions for samples start with the entire domain 210 and gradually shrink to the cell 136 size. One multi-resolution sampling process includes the following steps:

Step 1: Initialize resolution level L=0.

Step 2: Divide the sampling domain Q into 2^{nL} sub-domains. Visit these sub-domains in a random order and produce up to k samples uniformly drawn within each sub-domain. For each sub-domain, when a sample is found to be at least r distance from all existing samples, insert it into the grid and move on to the next sub-domain.

Step 3: While sub-domain size >r/√n, increment L and go to Step 2. This moves the computation to a higher resolution.

This multi-resolution sampling procedure attempts to produce one sample 204 uniformly drawn from the entire domain, (2ⁿ−1) samples 204 from sub-domains with a smaller size (½ in each dimension), (2²ⁿ−2ⁿ) samples 204 from sub-domains with an even smaller size (¼ in each dimension), and so on. Note that the gradually-decreasing sub-domain size provides convergence; if one keeps the entire domain throughout all “resolutions” then the approach reduces to a dart throwing approach. Some may consider this multi-resolution approach reminiscent of an approach discussed by McCool and Fiume (see Wei for all citations), but their method uses a gradually decreasing r whereas the present approach uses a fixed r but changes the size of the random sampling sub-domains. This random-order-plus-multi-resolution approach reduces or eliminates the biasing artifacts caused by visiting cells in a scanline order and by uniformly sampling from a grid cell, as illustrated in Figure Wei-2. To determine whether both random-order and multi-resolution affect the outcome, a test ran an implementation in scanline-order with multi-resolution; the results shown in Figure Wei-2 confirmed the presence of bias even though the bias was reduced by multi-resolution.

Some may consider this multi-resolution approach reminiscent of multi-resolution image processing, e.g., texture synthesis. However, within a multi-resolution framework the present approach uses sample point 314 locations rather than pixel color values and also uses sample conflict checks 316 rather than pixel neighborhood match. Traditional multi-resolution image processing theory is not directly applicable to the present method, since pixel colors and sample locations are quite different items.

Regular traversal order and grid cell sampling may be considered the only two sources of bias, as they are the only parts of an implementation that exhibited sampling regularity. Regular traversal order is perhaps easier to grasp conceptually, since a traversal order with directional bias will readily produce samples with spectrum alias; scanline order provides an extreme manifestation. Using a random order for traversal 138 can reduce or eliminate this bias.

Grid cell sampling is more complex. Some may characterize the present approach as a multi-resolution version of dart throwing. Under the original dart throwing process, each sample is drawn from the entire domain (maximum randomness per sample); this yields good sample statistics but is difficult to sample efficiently and to parallelize. The single resolution uniform sampling process presented above is another extreme, as it draws one sample from each grid cell, an approach which allows easy sampling but yields grid cell bias. The present multi-resolution sampling approach balances quality and efficiency by drawing samples with gradually reduced randomness in a multi-resolution fashion. In particular, samples generated at lower resolutions serve as constraints to reduce potential bias incurred by samples later generated at higher resolutions.

Parallel Uniform Sampling

A parallel uniform sampling generator 206, 134 includes aspects of the sequential uniform sampling generator discussed above, but uses a parallel sampling approach. The sequential approach above can be parallelized using the following observation: for a group of grid cells sufficiently far away from one another, their corresponding samples cannot be closer than the minimum distance r; consequently, samples drawn from these cells can be computed in parallel.

In some embodiments, the parallel sampling process works as follows. Similar to the sequential sampling process, the sample set 132 synthesis progresses in a multi-resolution fashion. Within each resolution, one partitions 328 the cells into disjoint phase groups 222 so that cells within each group are at least r distance away from one another, and thus can be sampled in parallel. The process produces samples by visiting one phase group after another.

One issue is how to specify the phase group partitioning, in terms of the number of groups, the structure of each group, and the traversal order among these groups. A given embodiment may have a goal of achieving the best possible sample set quality with the fewest number of computation passes. Several possible approaches are described below.

Some embodiments use a grid-partition-plus-scanline order traversal 138. For n-dimensional space, it can be shown that the minimum number of phase groups is ˜(┌√n┐+1)ⁿ and this can be achieved by a regular grid partition, as shown in Figure Wei-3 and in the following examples:

Grid partition with scanline order:

| | | | | | |
|---|---|---|---|---|---|
| 6 | 7 | 8 | 6 | 7 | 8 |
| 3 | 4 | 5 | 3 | 4 | 5 |
| 0 | 1 | 2 | 0 | 1 | 2 |
| 6 | 7 | 8 | 6 | 7 | 8 |
| 3 | 4 | 5 | 3 | 4 | 5 |
| 0 | 1 | 2 | 0 | 1 | 2 |

Random partition:

| | | | | | |
|---|---|---|---|---|---|
| 3 | 2 | 8 | 4 | 2 | 7 |
| 4 | 6 | 1 | 3 | 6 | 1 |
| 9 | 5 | 0 | 9 | 5 | 0 |
| 3 | 2 | 8 | 4 | 2 | 7 |
| 4 | 6 | 1 | 3 | 6 | 1 |
| 5 | 0 | 7 | 5 | 0 | 8 |

Grid partition with random order:

| | | | | | |
|---|---|---|---|---|---|
| 1 | 3 | 2 | 1 | 3 | 2 |
| 8 | 4 | 6 | 8 | 4 | 6 |
| 5 | 0 | 7 | 5 | 0 | 7 |
| 1 | 3 | 2 | 1 | 3 | 2 |
| 8 | 4 | 6 | 8 | 4 | 6 |
| 5 | 0 | 7 | 5 | 0 | 7 |

Figure Wei-3 illustrates phase group partitioning for parallel sample generation, showing a grid partition with scanline order, a random partition, and a grid partition with random order, with each phase group given a unique color. For the two grid partition cases (scanline order and grid-partition-plus-random-order) the ordering is also marked with numbers at the lower left corner of the image, like the examples above. A rule is used requiring that any two cells with the same id/color must be at least two cells apart.

There are several possible orders in which to visit the phase groups 222. A naive possibility is scanline order but this introduces similar bias artifacts to the scanline cell order discussed above and confirmed in Figure Wei-2.

Some embodiments use a random partition to eliminate the grid bias artifacts, such as a completely random phase partition like the one shown above and in Figure Wei-3. A random partition can be achieved by computing which associates a unique group-id with sub-domains within each phase partition as follows.

Step 1: Produce a randomly ordered list of sub-domains belonging to a given resolution. Initialize the group-id for each sub-domain as 0. Initialize the active-list to contain all sub-domains. Initialize the current-id as 0.

Step 2: If the active list is not empty, visit its sub-domains in the pre-randomized order. If a sub-domain has a group-id equal to current-id, remove it from the active list and update to (current-id+1) the group-ids of its neighboring sub-domains (those within r distance) that are still on the active list.

Step 3: Increment current-id and go to Step 2.

Experiments with different dimensions n and minimum distances r indicated that this heuristic approach produces a number of groups roughly twice the minimum achieved by the grid partition. The ratio remains nearly constant around two with different n and r parameter values, so the increase in the number of computation passes is only about twofold. The heuristic also produces a sufficiently random distribution of sub-domains within each group. By visiting the groups one by one (according to their group-id) while generating samples within each group in parallel, one is able to generate Poisson disk samples efficiently. Resulting sample sets exhibit blue noise spectrum similar to the ones shown in Figure Wei-4. However, one problem with this approach is that the computation of random phases remains a sequential process with computation time linearly proportional to the number of cells. This presents a potential bottleneck for parallel computation.

Some embodiments use a grid-partition-plus-random order, which may be viewed as combining good aspects of the two options presented above, namely, combining the speed and simplicity of a grid partition with the quality of a random partition. This approach uses a grid structure similar to the first option, but instead of a scanline order the traversal visits the groups in a random order, as illustrated in the example above and in Figure Wei-3. In one implementation, a number of phase groups ˜(2┌√n┐+1)ⁿ (i.e. twice the minimum possible number of phase groups in each dimension) was sufficient to produce samples with desired blue noise spectrum.

In some embodiments, the random order of the phase groups is pre-computed once per dimension and stored as a small precomputed 224 values array, and consequently does not present a bottleneck to parallel implementation. One can perform the pre-computation by generating a large number of random sequences and choosing one that produces an averaged power spectrum similar to the ground truth produced by dart throwing. This grid-partition-plus-random order approach was chosen for a final implementation discussed in Wei.

In review, using a sequential sampling approach with random traversal for grid cells suppresses sampling alias. In a parallel sampling approach the traversal order is modified to facilitate parallel grid cell sampling. Although grid-partition-plus-random order is not as random as a truly random permutation order, it can suppress grid traversal aliasing. In connection with an implementation discussed in Wei, it was not considered necessary for the sequence to satisfy rigorous statistical measurements. One approach tried to pre-compute a random partition over a small hypercubical set of cells followed by tiling over the target domain; in theory this could be expected to provide better quality than grid-partition-plus-random order but empirically noticeable differences were not found.

Adaptive Sampling

A parallel adaptive sampling generator 208, 134 may include aspects of the sequential sampling generators discussed above. In particular, the parallel uniform sampling process discussed above can be extended for use in adaptive sampling. Unlike the uniform sampling case where each sample has to keep the same minimum fixed distance r from one another, in adaptive sampling the user supplies a function r(.) over the sampling domain Ω, specifying the minimum distance r(s) for which sample s ε Ω has to be kept away from other samples.

A parallel adaptive sampling process is summarized in the following pseudo-code:

```
function ParallelAdaptiveSampling(Ω, r(. ), k)
  // Ω: sampling domain in n-dimension
  // r(. ): distance function defined over Ω
  // k: maximum number of trials per node
  T(0) ← BuildNDTreeRoot( ) // hypercube covering Ω
  l ← −1 // current level of T
  do // from coarse to fine, root to leaf of T
    l ← l + 1
    {p} ← ComputePhaseGroups(T(l))
    foreach phase group p in {p} // any two samples within two different
    nodes ∈ p
    // cannot conflict one another
      parallel foreach node c in p
        if c has no sample
          s ← ThrowSample(T, Ω(c), r(.), k, l)
          if s is not null add s to c end
        end
      parallel end
    end
    T(l + 1) ← Subdivide(Ω, r(.), T(l))
  while T(l + 1) not Ø
function T(l + 1) ← Subdivide(Ω, r(.), T(l))
  parallel foreach node c of T(l)
    if ∃s ∈ c and √nμ(c) > r(s)
    // subdivide c only if likely to add another sample
    // μ(c) is the cell size of c
      subdivide c into 2ⁿ child nodes // n is the dimension of Ω
      migrate s into the child c’ where s ∈ Ω(c’)
    end
  parallel end
  T(l + 1) ← newly created nodes
  return T(l + 1)
function s ← ThrowSample(T, Ω(c), r(.), k, l)
  foreach trial = 1 to k
    s ← sample uniformly drawn from Ω(c)
    if ∀s’ ∈ T |s − s’| ≧ max(r(s), r(s’))
    // this can be done by examining only s’ ∈ neighbor nodes
    // within hypersphere of radius 3√nμ(l’) at level l’ = 0 to l
      return s
  end
  return null
```

Some embodiments also use mean(r(s), r(s′)) (corresponding to geometric disks) instead of max(r(s), r(s′)) in ThrowSample( ). In that case, use 5√nμ(l′) instead of 3√nμ(l′) in ThrowSample( ) and r(s)/2 instead of r(s) in Subdivide( ). Additional math details which may be of academic interest are provided in a Wei appendix.

Similar to a uniform sampling process, the adaptive sampling process utilizes an acceleration data structure around the domain for generating samples. However, instead of a uniform grid, some embodiments use a hierarchical nd-tree structure for adaptive sampling; nd means n-dimensional. An nd-tree is a high dimensional equivalence of quad-tree in 2D and oc-tree in 3D. One may build the nd-tree layer-by-layer on the fly after samples on the previous level are computed, using a process as follows.

Begin with a single root node covering the entire domain Ω. For each node c on leaf level l of the tree, if it has no sample within, try to generate one by uniform sampling from its domain Ω(c). This trial is repeated for at most k times and stops at the first sample that is not in conflict with any existing samples. It can be shown that this conflict check 316 can be conducted by examining, at level l′, for l′=0 to l, existing samples at neighboring nodes {c′(l′)} whose centers are within 3√nμ(l′) (μ(l′) indicates cell size at level l′) distance from the center of the ancestor node c(l′) containing c; a proof is provided in a Wei Appendix.

After samples are deposited for level l, perform subdivision at a subset of the nodes at that level. For each node c in level l, subdivide 342 it into 2ⁿ uniformly-sized sub-nodes if c has a sample s within it (there can be at most one such sample) and it is possible to add more samples within Ω(c) (this is true when √nμ(c)>r(s)). If c is subdivided, migrate its sample s to the child c′ whose domain Ω(c′) contains s. Consequently, interior nodes in the nd-tree 214 possess no samples and each leaf node can possess at most one sample (similar to the uniform grid used in the uniform sampling process). The uniform sampling process can be considered as a special case of this adaptive sampling process with a complete nd-tree.

This adaptive sampling process can also be parallelized, similar to the uniform sampling algorithm. For all nodes within the same level of the nd-tree, perform a phase partition as in the parallel uniform sampling process, and sample nodes within the same phase group concurrently. Similar to the uniform sampling process, an embodiment may use a grid-partition-plus-random order with twice the minimally possible number of phase groups at each dimension (i.e. (2*┌3√n┐)ⁿ since any two nodes ┌3√n┐ cells apart cannot have conflicting samples).

Examples are provided above and elsewhere to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

Configured Media

Some embodiments include a configured computer-readable storage medium 114, which is an example of a memory 112. Memory 112 may include disks (magnetic, optical, or otherwise), RAM, EEPROMS or other ROMs, and/or other configurable memory. The storage medium which is configured may be in particular a removable storage medium 114 such as a CD, DVD, or flash memory. A general-purpose memory 112, which may be removable or not, and may be volatile or not, can be configured into an embodiment using items such as generators 134, in the form of data 118 and instructions 116, read from a removable medium 114 and/or another source such as a network connection, to form a configured medium. The configured memory 112 is capable of causing a computer system to perform method steps for generating stochastic sample set(s) 132 by transforming data as disclosed herein. FIGS. 1 through 3 thus help illustrate configured storage media embodiments and method embodiments, as well as system and method embodiments. In particular, any of the method steps illustrated in FIG. 3, or otherwise taught herein, may be used to help configure a storage medium to form a configured medium embodiment.

Some embodiments provide a computer-readable medium 114 configured with data 118 and instructions 116 for performing a method for generating a Poisson disk sample set 132 for use in graphics production. The method includes specifying 302 a grid 212 having cells 136 which are bounded in size to each contain at most one sample 204 when samples are at least a given distance r from one another, and adding 306 samples to the sample set in parallel while traversing 308 the grid cells in a traversal 138 order. Each added sample is at least a given distance r from any other added sample, and the added samples collectively form a Poisson disk. In some embodiments, the grid cells are bounded in size by r divided by the square root of n, where n is an integer greater than 2 representing the dimensionality of a sampling domain 210 from which the sample set is generated. Some embodiments output 330 a graphic image which was produced using the Poisson disk sample set; some use 332 the sample set for other graphics production purposes.

In some embodiments, the method further includes partitioning the grid cells into a plurality of groups 222, and the step of adding samples adds 306 samples in parallel to different cells of a given group. In some embodiments the traversal order visits all cells of one group before visiting cells of another group, and the traversal order visits the groups in a random order. More generally, the traversal 138 order may include traversal in at least one of the following orders: a scanline order, a grid-partition-plus-scanline order, a random-partition order, a random-with-multi-resolution order, a grid-partition-plus-random order.

Implementation Considerations

For improved efficiency, care can be taken as follows when performing a conflict check 316 for a newly generated trial sample s. According to one adaptive sampling process, for each new s uniformly randomly sampled from a node c(l) at tree level l, an embodiment examines existing samples within each leaf node c′(l′) (with 0≦l′≦l) whose center is at most 3√nμ(l′) away from c(l′), the ancestor node at level l′ whose domain contains s. One naive implementation is to examine a hypercube with size 6√nμ(l′) around c(l′), but this may well be too computationally expensive as the cost is exponential in terms of the dimensionality n. One implementation instead examines only a hypersphere with radius 3√nμ(l′), as the volumes of hyperspheres grow much slower than hypercubes. Despite this, the potential number of neighbors that have to be checked 316 can still get quite large, as shown below.

Neighborhood size for conflict checking:

measured

| n | hypercube | hypersphere | best | worst |
|---|---|---|---|---|
| 2D | 81 | 61 | 3.92 | 4.38 |
| 3D | 1331 | 619 | 8.15 | 9.66 |
| 4D | 28561 | 6577 | 20.12 | 24.87 |
| 5D | 371293 | 72797 | 58.44 | 69.02 |
| 6D | 11390625 | 829201 | 177.57 | 201.30 |

The foregoing table shows the number of neighborhood nodes that have to be checked for potential conflicts for different dimensions n and different neighborhood shapes. As shown, using a naive hypercube shaped neighborhood would incur much more computation than a hypersphere, especially at higher dimensions. The right-most two columns show the average number of neighbors visited at run-time for best and worst case scenarios. (Let rₜ be a threshold r value for triggering cell subdivision as described in the ParallelAdaptiveSampling pseudo-code listing. The best case scenario is achieved with a r_{b} slightly larger than rₜ, and the worst case with a r_{w} slightly smaller than rₜ.) Notice that these numbers are much smaller than their theoretical counterparts shown on the same row.

An optimization can be used to reduce the cost of this potentially large number of neighbors for conflict checking, by reducing the number of neighbors actually checked. For each conflict checking operation around a new sample's node 216, visit 338 its neighboring nodes in an inside-to-outside fashion. Since nearby nodes are more likely to contain conflicting samples, this allows an embodiment to terminate the process when a nearby conflict is found. As shown in the neighborhood size for conflict checking table above (column “measured”), at run time the actual number of neighbors checked is then much smaller than the worst case scenario across different dimensions.

Implementation on a GPU of a sampling process taught herein was straightforward when the information noted above was considered. In the following pseudo-code for the implemented process, the final sample locations are available at the last map(l, σₗ,):

```
function ParallelAdaptiveSamplingGPU
  foreach level l from coarse to fine
    construct framebuffer objects map(l, 0) and map(l, 1)
    σ ← 0 // source selection - ping pong between 2 maps
    // with map(l, σ) the input texture and
    // map(l, 1 − σ) the output render target
    if l > 0
      initialize map(l, σ) from map(l − 1, σ_{l - 1})
      // initialization done similar to Subdivide( ) in Listing 1
      // mask out nodes not subdivided from parents
    foreach trial from 0 to k − 1
      foreach phase group p
        map(l, 1 − σ) ← map(l, σ) // initialize render target
          foreach pixel s ∈ map(l, 1 − σ)
          // do following in the pixel shader
          if s ∉ p or s not empty or s masked out
              discard // fragment kill
          s ← random sample
          // similar to ThrowSample( ) in Listing 1
          if s conflict any neighbor
              discard
          output pixel s
        end
        σ ← 1 − σ // next rendering pass
      end
    end
end
```

Two practical implementation issues are memory storage and random number generation. For storage, one implementation uses framebuffer objects (FBO) for generated sample locations, as they are read-write data locations (e.g., output render target in one pass and input texture the next). The implementation produces the samples from lower to higher nd-tree resolutions, and begins each resolution with initialization from lower resolution results. Within each resolution, the implementation uses two framebuffer objects to ping-pong the sample locations across different k trials and phase groups, e.g., one FBO serves as texture and another as render target, with their roles swapped in the next rendering pass. Since GPUs are designed mainly for 2D textures and render targets, higher dimensional data structures are implemented by packing multiple 2D slices into a single 2D render target. For example, a 3D map is represented as a 1D stack of 2D regions, and a 4D map as a 2D grid of 2D regions.

As an optimization, the implementation lays out pixels belonging to the same phase group spatially near each other. This may incur some extra pixel location map arithmetic but results in faster total run time due to more coherent memory IO.

Current GPUs do not provide a random number generator, so one was implemented. For example, an implementation can use the hash-based method presented by Tzeng and Wei for GPUs supporting integer arithmetic (e.g., NVIDIA G80), or an implementation can pre-compute the uniform random numbers and store the results in (up to k) textures, for older generation GPUs.

Note that unlike the CPU case where a process performs up to k trials per grid cell before moving to the next one, this GPU implementation performs only one trial per cell within a phase group before moving on to the next group, and repeats this process up to k times. Quality-wise, this reduces a potential bias that favors more samples for earlier phase groups. Performance-wise, this allows the implementation to read one random number texture at one time, resulting in much better texture cache performance.

As discussed above, it is better to visit neighbor nodes in an inside-to-outside fashion during conflict check. This traversal is used in the GPU implementation as well, which discards the fragment immediately once a sample is found in conflict with existing samples. This not only avoids extra texture reads/writes but also permits the implementation to finish a computation-pass earlier. For adaptive sampling, instead of implementing a full nd-tree, the implementation uses a complete texture and masks out non-existing nd-tree nodes (via a special value) during the initialization step. Although it is possible to implement an nd-tree on a GPU, this masking approach provides simplicity and efficiency.

In addition to being parallel, some sampling processes taught herein are also order-independent, namely, an embodiment can compute a proper subset of the sample set while guaranteeing that the subset's samples are the same as if the entire sample set were generated. This order-independence could be useful for situations where the entire sampling domain is huge but at a single instance of time or frame a system 102 only needs a subset of the samples. Aspects of order-independent texture synthesis can be employed since, similar to neighborhood match in these methods, the present sampling process examines only a small set of spatial neighbors for conflict check with a new sample: those generated at lower resolutions, or those at the same resolution but at an earlier pass (either a smaller k or the same k but in an earlier phase group). Thus, the dependency group of each sample is constant, and one can pre-determine a minimally necessary set of samples per resolution from a given request set. At run time, the implementation runs from low to high resolutions as discussed above, but at each resolution and each pass computes only the minimal set instead of all samples covering the entire domain. A random number generator that guarantees order-independence can be achieved, e.g., via the hashing method discussed by Tzeng and Wei (using k as the key and texture coordinates as the input).

With regard to parameters, the implementation is easy to use. Aside from the mandatory parameters n and r(.), the only user-tunable parameter is k. Experimentally, picking k in the range of [4 10] works well in practice as this would capture the majority of the samples, as illustrated in the table below. It appears that k only affects the size of the “inner ring” as a result of different number of samples generated, not the quality, of the power spectrums.

Samples generated for k values:

| | k | | | | | | | | | |
|---|---|---|---|---|---|---|---|---|---|---|
| n | 1 | 2 | 3 | 4 | 5 | 6 | 7 | 8 | 9 | 10 |
| 2D | 65 | 78 | 83 | 87 | 89 | 91 | 92 | 93 | 94 | 94 |
| 3D | 62 | 74 | 80 | 84 | 86 | 88 | 90 | 91 | 92 | 93 |
| 4D | 62 | 74 | 79 | 83 | 85 | 87 | 89 | 90 | 91 | 92 |
| 5D | 64 | 74 | 79 | 83 | 85 | 87 | 88 | 89 | 90 | 91 |
| 6D | 65 | 74 | 79 | 83 | 85 | 87 | 88 | 90 | 90 | 91 |

Each table entry above indicates the percentage of samples generated with a particular k with respect to the maximum possible number of samples generated with a very large k_{inf}. Notice the diminishing returns when k increases.

One measure of the quality of Poisson disk sampling methods uses two criteria, namely, power spectrum together with associated radial mean and anisotropy measurements, and the relative radius ρ=r/rₘₐₓ where rₘₐₓ is the maximum average inter-sample distance computed from the maximum packing of a given number of samples. The implementation produced samples exhibiting blue-noise power spectrums with desired radial mean and low anisotropy, as discussed in Wei, with sample distribution very similar to brute force dart throwing. The implementation produced distributions with ρ in the range [0.65 0.85] as recommended by Lagae and Dutré; see Wei for this and other citations.

With regard to performance, the implementation running on a commodity GPU in the 2D case generated more than 4 million samples per second; this computation speed compares favorably with hierarchical dart throwing and boundary sampling, as discussed in Wei. The performance gap between parallel and sequential algorithms will likely widen further on future GPUs and multi-core CPUs. The implementation performance is similar to performance of techniques using pre-computed 2D datasets, such as recursive Wang tiles and Polyominoes, but does not need to store any pre-computed dataset (which could consume a significant amount of GPU memory). Due to the multi-pass rendering nature of the implementation, it has lower samples-per-second ratio at lower resolutions and the optimal performance is achieved with a sufficiently large number of samples. To reap the best performance of the Wei implementation, it is usually beneficial to use a CPU to compute the few samples at lower resolutions and then switch to a GPU for higher resolutions. For example, in the 2D case the implementation computes the first 4 levels (up to texture size 8×8) on a CPU. In higher dimensional cases, the performance of the implementation decreases, due to increased theoretical computational complexity (larger number of neighborhood nodes for conflict check, more computation phases, and longer coordinate vector length) as well as reduced texture cache coherence and other GPU-specific performance issues. The performance for 5D and 6D is further degraded by use of multiple render targets to store samples with dimensionality greater than 4.

The sampling approach described above is also applicable for adaptive sampling. Given a user-specified importance field function l(.), compute a distance field r(.) proportional to l(.)^{(-1/n)} and use that to drive an adaptive sampling process. For adaptive sampling with a high-varying importance field, a method might prematurely terminate the subdivision of a node due to the rejection of early trial samples, but this can be addressed by using a larger k value.

The implementation lacks the capability for fine-grain sample ranking, a feature useful for applications such as continuous zoom-in. The sample sets generated are not guaranteed to be maximal, and it can be difficult to control the exact number of samples generated. Also, the maximum number of samples that can be produced in a single run in the implementation is limited by maximum texture size (about 1 million 2D samples per run via a 2K×2K texture on the specific GPU used). Producing more samples would require multiple runs but the order-independence nature of the algorithm would make the process consistent. Also, the implementation handles only Euclidean spaces. Other implementation results and observations are also discussed in Wei.

Conclusion

Although particular embodiments are expressly illustrated and described herein as methods, as configured media, or as systems, it will be appreciated that discussion of one type of embodiment also generally extends to other embodiment types. For instance, the descriptions of methods in connection with FIG. 3 also help describe configured media, and help describe the operation of systems and manufactures like those discussed in connection with FIGS. 1 and 2. It does not follow that limitations from one embodiment are necessarily read into another. In particular, methods are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or methodological acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

What is claimed is:

1. A method for generating a stochastic sample set for use in graphics production, the method comprising the steps of:
specifying a collection of cells which are bounded in size to each contain at most one sample when samples are at least a specified distance r from one another; and
adding samples to the sample set in parallel while traversing the cells in a traversal order, each added sample being at least the specified distance r from any other added sample, and the added samples collectively form a stochastic set.

2. The method of claim 1, wherein the cells are bounded in size by r divided by the square root of n, where n is an integer greater than 1 representing the dimensionality of a sampling domain from which the sample set is generated.

3. The method of claim 1, further comprising randomly selecting up to k points within a given cell, adding a randomly selected point to the sample set if it is at least the specified distance r from each point already in the sample set, and leaving the given cell empty of samples and continuing traversing the cells if none of the k randomly selected points is at least the specified distance r from each point in the sample set, where k is a positive integer.

4. The method of claim 1, wherein the traversal order visits cells in a random order.

5. The method of claim 1, wherein the collection cells are organized in a grid, and the method further comprises specifying a sequence of grids, each successive grid having cells smaller than the preceding grid, while continuing to require that samples are at least the specified distance r from one another, and wherein the traversal order visits cells of a given maximum size before visiting smaller cells.

6. The method of claim 1, wherein the collection cells are organized in a grid, and the method further comprises specifying a sequence of grids, each successive grid having cells smaller than the preceding grid, and the traversal order visits cells in a random order for cells of a given maximum size while continuing to require that samples are at least the specified distance r from one another.

7. The method of claim 1, wherein the collection cells are organized in an n-dimensional tree of nodes in a sampling domain and the specified distance r is a variable distance provided by a function over the sampling domain.

8. A computer-readable medium configured with data and instructions for performing a method for generating a Poisson disk sample set for use in graphics production, the method comprising the steps of:
specifying a grid having cells which are bounded in size to each contain at most one sample when samples are at least a given fixed distance r from one another; and
adding samples to the sample set in parallel while traversing the grid cells in a traversal order, each added sample being at least the given fixed distance r from any other added sample, and the added samples collectively form a Poisson disk.

9. The configured medium of claim 8, wherein the grid cells are bounded in size by r divided by the square root of n, where n is an integer greater than or equal to 2 representing the dimensionality of a sampling domain from which the sample set is generated.

10. The configured medium of claim 8, wherein the method further comprises partitioning the grid cells into a plurality of groups, and wherein the step of adding samples adds samples in parallel to different cells of a given group.

11. The configured medium of claim 10, wherein the traversal order visits all cells of one group before visiting cells of another group, and the traversal order visits the groups in a random order.

12. The configured medium of claim 8, wherein the traversal order includes traversal in at least one of the following orders: a scanline order, a grid-partition-plus-scanline order, a random-partition order, a random-with-multi-resolution order, a grid-partition-plus-random order.

13. The configured medium of claim 8, wherein the method further includes outputting a graphic image which was produced using the Poisson disk sample set.

14. A computer system configured with a stochastic sample set, the system comprising:
a logical processor; and
a memory in operable communication with the logical processor, the memory configured with a stochastic sample set and with code for controlling the logical processor, the stochastic sample set having been produced by the system performing with the code a method having at least the following steps:
specifying a sequence of cell collections, each successive collection having cells smaller than the preceding collection; and
adding samples to the sample set in parallel while traversing the collection cells in a traversal order, the traversal order visiting cells of a given maximum size before visiting smaller cells, each added sample being at least a specified distance r from any other added sample, and the added samples collectively form the stochastic set.

15. The system of claim 14, wherein the system is configured for parallel uniform sampling in that the specified distance r is a fixed value.

16. The system of claim 14, wherein the system is configured for parallel adaptive sampling in that the cell collections are specified in a sampling domain and the specified distance r is provided by a function over the sampling domain.

17. The system of claim 16, wherein the method performs parallel adaptive sampling in that the cell collections are specified in an n-dimensional tree.

18. The system of claim 14, wherein the method's traversal order visits neighbor cells of a cell in an inside-to-outside order.

19. The system of claim 14, wherein the method configures the memory with a stochastic sample set in the form of a Poisson disk sample set.

20. The system of claim 14, wherein the logical processor comprises a graphical processing unit.
